(19) United States
(12) Patent Application Publication
(10) Pub. No.: US 2016/0223990 A1
(43) Pub. Date: Aug. 4, 2016

(54) ELECTRONIC TIMEPIECE, ELECTRONIC TIMEPIECE SYSTEM AND METHOD OF CONTROLLING ELECTRONIC TIMEPIECE

(71) Applicant: SEIKO INSTRUMENTS INC., Chiba-shi (JP)

(72) Inventor: Kazuhiro KOYAMA, Chiba-shi (JP)

(21) Appl. No.: 14/995,320

(22) Filed: Jan. 14, 2016

(30) Foreign Application Priority Data
Feb. 2, 2015 (JP) 2015-018599
Oct. 20, 2015 (JP) 2015-206697

(51) Int. Cl. G04B 19/04; G04C 3/14

(52) U.S. Cl. CPC G04B 19/04; G04C 3/14

(57) ABSTRACT

To operate hands with rich expression. Hands 34, 36 and 38 are driven to be rotated along a display dial. A drive section 52 drives the hands 34, 36 and 38. An acquisition section 48 acquires commands for controlling the hands 34, 36 and 38 regardless of the time. A controller 50 outputs a control signal for controlling the drive section 52 based on the acquired command acquired by the acquisition section 48.

### BACKGROUND OF THE INVENTION

1. Field of the Invention

The present invention relates to an electronic timepiece, an electronic timepiece system and a method of controlling the electronic timepiece.

2. Description of Related Art

An analog electronic timepiece mounted on a portable electronic device has been hitherto known (for example, JP-A-2010-271239 (Patent Literature 1)). The analog electronic timepiece controls hands based on a signal for moving hands transmitted from the portable electronic device when a power source of the portable electronic device has an enough voltage for the operation. On the other hand, in the case where the power source does not have enough voltage for operating the portable electronic device, the control for moving hands of the analog electronic timepiece is performed by the device itself. Accordingly, the analog electronic timepiece can continue the operation of ticking time away without stopping.

However, in the related-art analog electronic timepiece mounted on the portable electronic device, it is necessary to perform setting in consideration of the load of hands, a wheel train and so on and characteristics of a motor to be a driving source for controlling the movement of hands such as a minute hand and an hour hand, and the complicated setting for controlling the operation of hands is not easy.

The present invention has been made in view of the above problems, and an object thereof is to provide an electronic timepiece, an electronic timepiece system and a method of controlling the electronic timepiece capable of operating hands with rich expression while facilitating the setting for controlling the movement of hands.

### SUMMARY OF THE INVENTION

According to an embodiment of the present invention, there is provided an electronic timepiece including hands driven to be rotated along a display dial, a drive section driving the hands, an acquisition section acquiring a command for controlling the hands regardless of the time and a controller outputting a control signal for controlling the drive section based on the command acquired by the acquisition section. According to the present invention, the hands can be operated with rich expression.

The electronic timepiece according to the present invention may include the hands driven to be rotated along a display dial, the drive section driving the hands, the acquisition section acquiring a command for controlling the hands regardless of the time and the controller outputting a control signal for controlling the drive section based on the command acquired by the acquisition section.

In the electronic timepiece according to the present invention, the drive section may be a stepping motor operating based on a pulse, a storage section storing correspondence relation between the command and physical quantities corresponding to control items of the stepping motor may be included, and the controller may control the stepping motor based on the obtained physical quantities by referring to the correspondence relation stored in the storage section by using the command acquired by the acquisition section.

In the electronic timepiece according to the present invention, the control items may include items concerning the hands to be controlled, the number of steps of the stepping motor corresponding to target angles of hands to be driven, the rotation direction of hands and the rotation speed of hands.

The electronic timepiece according to the present invention may further include a hand position detector which can detect current angles of the hands by detecting positions of hands, in which physical quantities corresponding to the control items may include physical quantities based on the difference obtained by comparing the target angle to be driven with the current angle.

In the electronic timepiece according to the present invention, the acquisition section may acquire at least one of a first command and a second command as the command, and the storage section may store at least a first motor control setting table corresponding to the first command and a second motor control setting table corresponding to the second command as the correspondence relation.

In the electronic timepiece according to the present invention, the correspondence relation may include physical quantities to be set as values fulfilling functions including a receiving notification of an e-mail and a count-down timer. In the electronic timepiece according to the present invention, the acquisition section may acquire information indicating the correspondence relation, and the controller may allow the storage section to store information indicating the correspondence relation acquired by the acquisition section.

An electronic timepiece system according to the present invention may include the above electronic timepiece and an electronic device including a communication section which can communicate with the acquisition section and can transmit/receive the command, which is stacked over/under the electronic timepiece.

In the electronic timepiece system according to the present invention, the electronic timepiece may transmit a request signal to the electronic device, which requests transmission of the command to the acquisition section.

In the electronic timepiece system according to the present invention, the electronic timepiece may transmit a control end signal to the electronic device by the command, which notifies the end of control in a state where the control of the drive section based on the control items and physical quantities corresponding to the command is completed.

In the electronic timepiece system according to the present invention, the electronic device may include a power source, and the electronic timepiece includes a power source different from the above power source.

In the electronic timepiece system according to the present invention, the electronic device may be mounted on an attaching portion which can be attached to a user's arm in a state where the electronic timepiece is stacked.

A method of controlling the electronic timepiece according to the present invention may include the steps of acquiring a command for controlling hands driven to be rotated along a display dial regardless of the time, storing correspondence relation between the command and physical quantities corresponding to control items of a drive section which drives the hands and controlling the drive section based on the obtained physical quantities by referring to the correspondence relation by using the acquired command to drive the hands.

According to the present invention, the electronic timepiece can control the drive section based on the acquired command, therefore, it is possible to operate the hands with rich expression though the instruction contents from the outside are simple.

### BRIEF DESCRIPTION OF THE DRAWINGS

FIG. 1 is a perspective view of an electronic timepiece system 1;

FIG. 2 is a functional configuration diagram of the electronic timepiece system 1;

FIG. 3 is a sequence diagram showing the flow of processing executed by the electronic timepiece system 1;

FIGS. 4A and 4B are flow charts showing processing executed by an electronic timepiece 30;

FIG. 5 is a data structure diagram of the electronic timepiece system 1;

FIG. 6 is a view showing an example of a motor control setting table;

FIG. 7 is a view for explaining a state in which hands are controlled based on the motor control setting table;

FIG. 8 is a view for explaining a rotating operation;

FIG. 9 is a view for explaining an opening operation;

FIG. 10 is a view for explaining an operation of gathering at one point;

FIG. 11 is a view for explaining a stopwatch operation;

FIG. 12 is a view for explaining a count-down timer operation;

FIG. 13 is a view for explaining an operation of being the time;

FIG. 14 is an appearance view of an electronic timepiece unit 30A according to a second embodiment;

FIG. 15 is a functional configuration diagram of the electronic timepiece unit 30A according to the second embodiment;

FIG. 16 is a sequence diagram showing the flow of processing executed by the electronic timepiece system 1 according to the second embodiment;

FIG. 17 is a view for explaining a case of acquiring a command from an external device and so on; and

FIG. 18 is a view showing an example of a motor control setting table.

### DESCRIPTION OF EMBODIMENTS

Hereinafter, an electronic timepiece, an electronic timepiece system and a method of controlling the electronic timepiece system will be explained with reference to the drawings.

### First Embodiment

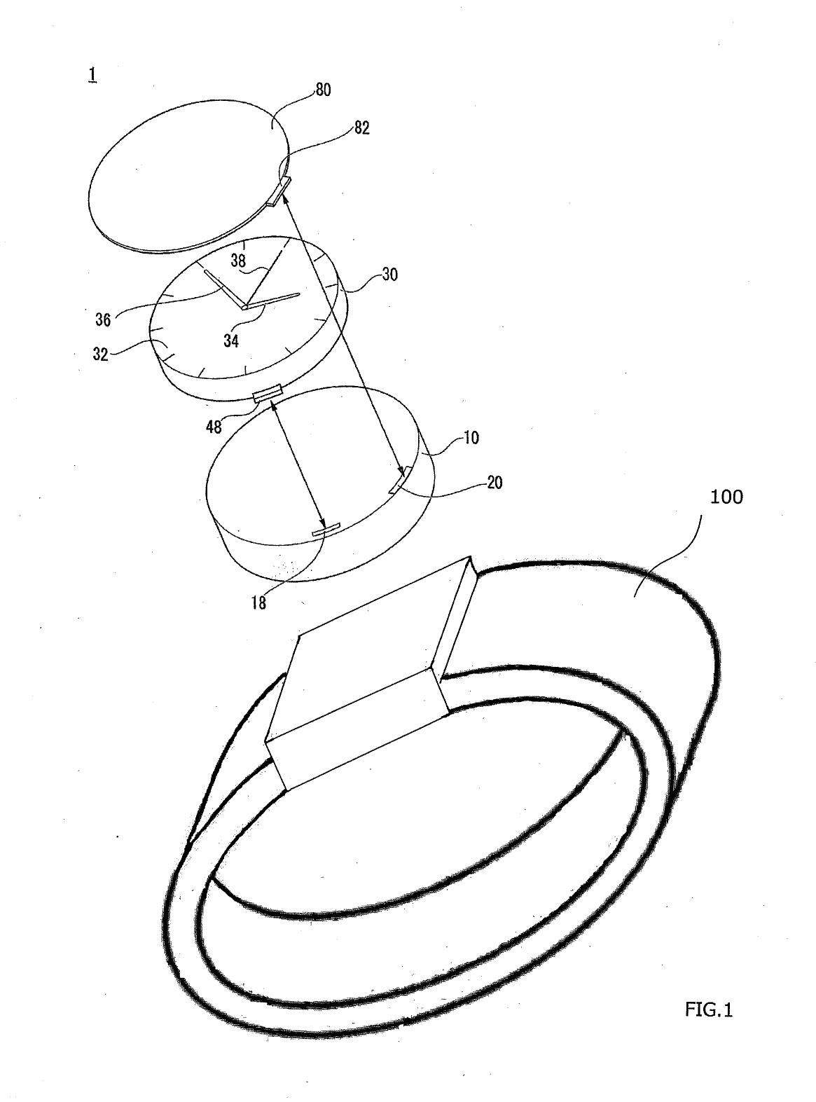

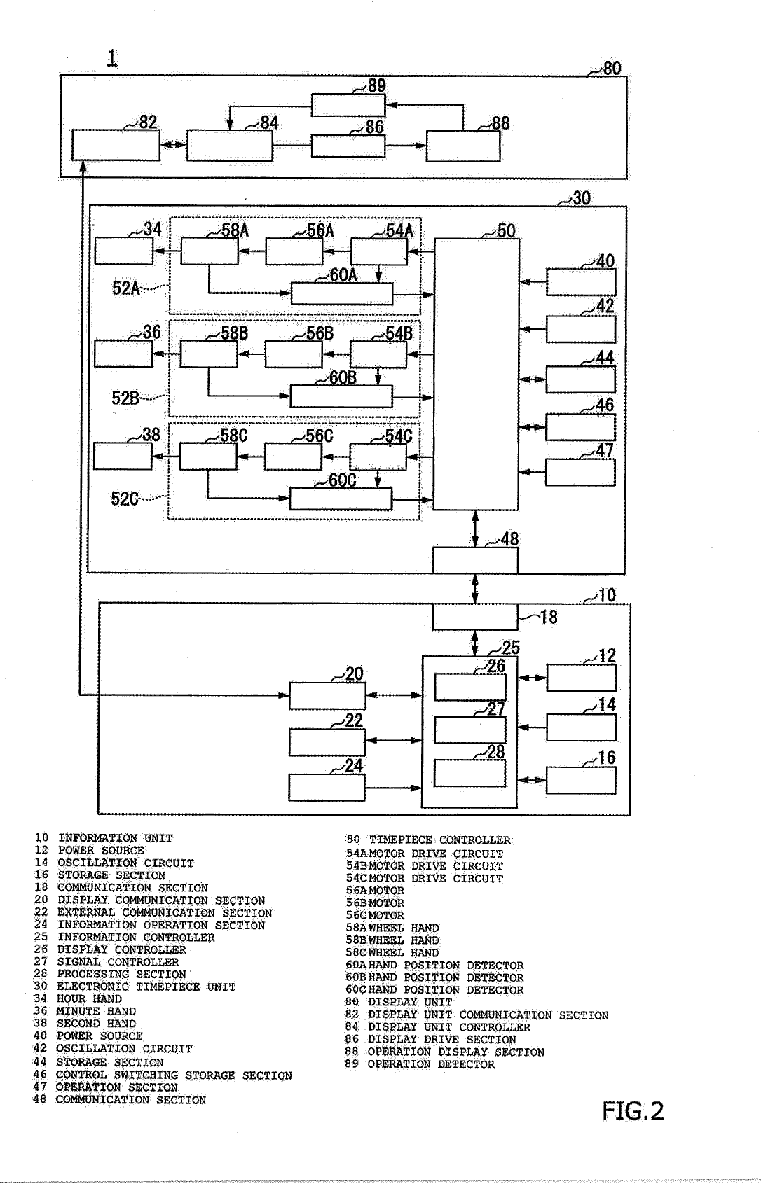

FIG. 1 is a perspective view of an electronic timepiece system 1. FIG. 2 is a functional configuration diagram of the electronic timepiece system 1. The electronic timepiece system 1 includes an information unit (electronic device) 10, an electronic timepiece unit (electronic timepiece) 30 and a display unit 80. The electronic timepiece system 1 is formed by stacking, for example, the information unit 10, the electronic timepiece unit 30 and the display unit 80 in this order. A direction of stacking will be a rotation axis direction of a later-described hour hand 34.

The information unit 10 is a smartwatch as an electronic timepiece, for example, having a wireless communication function and capable of installing application programs. Therefore, the information unit 10 takes a form of being mounted on a wrist band (attaching portion) 100 which is attached to an arm or the like of a user. The information unit 10 may be integrated with the wrist band 100 to form one smartwatch product. The information unit 10 is also an electronic device installing an operating system (OS) for controlling the information unit 10 to operate. The information unit 10 can also install application programs from the outside through an external communication section 22 as well as can execute installed programs. The information unit 10 can communicate with other communication devices such as a smartphone which can have access to, for example, a network. The information unit 10 may also be an electronic device which can have access to a base station or a network by the device itself.

The information unit 10 includes a power source 12, an oscillation circuit 14, a storage section 16, a communication section 18, a display communication section 20, the external communication section 22, an information operation section 24 and an information controller 25. The power source 12 is, for example, a storage battery. The power source 12 supplies the power for operating the information unit 10, for example, during a day to several days by one charging. The oscillation circuit 14 has, for example, a crystal oscillator. The oscillation circuit 14 outputs a signal for ticking time away inside the information unit 10 to the information controller 25. The storage section 16 stores information based on an instruction from the information controller 25. The storage section 16 stores application programs installed by the user or an API (Application Programming Interface). The communication section 18 performs communication with a communication section 48 of the electronic timepiece unit 30. The display communication section 20 performs communication with the display unit 80. The display communication section 20 performs communication, for example, by being connected to a display unit communication section 82 through a wire. The external communication section 22 performs communication with other communication devices such as a smartphone. For example, a communication system based on Bluetooth (registered trademark) standard can be adopted. The external communication section 22 has a function of connecting to access points such as a base station, a wireless LAN, Wi-Fi (Wireless Fidelity) and so on. The information operation section 24 outputs a signal based on an operation input by an operator to the information controller 25.

The information controller 25 includes a display controller 26, a signal controller 27 and a processing section 28. The information controller 25 generates a control signal corresponding to an operation input with respect to GUI (Graphical User Interface) switches displayed on the information operation section 24 by executing the application program and outputs the generated signal to the electronic timepiece unit 30. The display controller 26 outputs a signal for controlling the display unit 80 to the display unit 80. The signal processing section 27 outputs a signal for controlling the electronic timepiece unit 30 to the electronic timepiece unit 30. The processing section 28 controls respective sections of the information unit 10.

The electronic timepiece unit 30 includes a display dial 32, an hour hand 34, a minute hand 36, a second hand 38, a power source 40, an oscillation circuit 42, a storage section 44, a control switching storage section 46, an operation section 47, a communication section 48, a timepiece controller 50 and hand drive sections 52A to 52C. Respective functional sections of the timepiece controller 50 are software function sections functioning by processors such as a CPU (Central Processing Unit) included in the electronic timepiece unit 30 executing a program stored in a program memory. Part or all of respective function sections of the timepiece controller 50 may be hardware function sections such as a LSI (Large Scale Integration) and an ASIC (Application Specific Integrated Circuit). The storage section 44 and the control switching storage section 46 are storage devices such as a RAM (Random Access Memory), a HDD (Hard Disk Drive) and a flash memory.

The display dial 32 is a board on which characters, symbols and numerals indicating the time are displayed. The hour hand 34 indicates, for example, an hour of the time and the minute hand 36 indicates, for example, a minute of the time. The second hand 38 indicates a second of the time. When the hour hand 34, the minute hand 36 and the second hand 38 are not distinguished from one another, they are written as merely “timepiece hands” or “hands”.

The power source 40 supplies the power for driving respective sections of the electronic timepiece unit 30. The power source 40 is, for example, a primary battery or a secondary battery (including a solar battery which generates the power by using light and the like). When using the primary battery or the secondary battery, the primary battery or the secondary battery has an ability of supplying the power for operating the electronic timepiece unit 30, for example, for several days to several years without changing or charging the battery. Even when the voltage of the information unit 10 is reduced to a given value or less, the electronic timepiece unit 30 can continue operating by the power supply from the power source 40.

The oscillation circuit 42 includes, for example, a crystal oscillator. The oscillation circuit 42 outputs a hand movement timing to the timepiece controller 50. The storage section 44 stores information based on the control of the timepiece controller 50. The control switching storage section 46 stores controlling manners of movement of hands. That is, the control switching storage section 46 stores whether the timepiece hands are controlled at an oscillation timing by the oscillation circuit 42 of the electronic timepiece unit 30 or the timepiece hands are controlled based on a control signal acquired from the information unit 10. The operation section 47 is, for example, a winding drown which outputs the operation result (for example, a rotating operation and a pressing operation) operated by the user to the timepiece controller 50.

The communication section 48 is connected to, for example, the communication section 18 of the information unit 10 through a wire, performing communication with each other. Communication standards such as a serial interface, I²C (Inter-Integrated Circuit) and a SPI (Serial Peripheral Interface) can be used for communication. The communication section 48 may also perform wireless communication such as Bluetooth (registered trademark) with the communication section 18 of the information unit 10. The communication section 48 may also have a function of communicating with other communication devices or access points for having access to the base station and the network.

The timepiece controller 50 controls respective sections of the electronic timepiece unit 30. The timepiece controller 50 updates time information and controls the hand drive sections 52A to 52C based on the hand movement timing oscillated from the oscillation circuit 42. The timepiece controller 50 also determines whether the control of the timepiece hands is performed by the device itself or performed based on the signal transmitted from another device and controls the hand drive sections 52A to 52C based on the determined manner. The details of the processing executed by the timepiece controller 50 will be described later.

The hand drive sections 52A to 52C are drive sections for moving the timepiece hands. The hand drive sections 52A to 52C respectively have motor drive circuits 54A to 54C, motors 56A to 56C, wheel hands 58A to 58C and hand position detectors 60A to 60C. When component functions included in these respective parts are not distinguished from one another, A to C added to numerals are not written. The explanation will be made on the assumption that the electronic timepiece 30 has the hand position detectors 60A to 60C in the embodiment, however, it is not always necessary to have the hand position detectors 60A to 60C as well as any one or two hand position detectors in the hand position detectors 60A to 60C may be provided.

The motor drive circuit 54 generates a drive pulse for driving the motor 56 based on a signal outputted from the timepiece controller 50. The motor 56 rotates based on the drive pulse generated by the motor drive circuit 54. The motor 56 is, for example, a stepping motor operating in synchronized with the drive pulse. The timepiece hand rotates once through the wheel hand 58 when the stepping motor rotates by a unit angle (180 degrees). The unit angle corresponds to one step. The wheel hands 58 are a wheel train (gear train) connected to rotation shafts of the motors 56. Respective gears of the wheel hands 58 are rotated by the rotation of the rotation shafts of the motors 56, which rotate the hour hand 34, the minute hand 36 or the second hand 38.

The hand position detectors 60A to 60C respectively detect positions of the hour hand 34, the minute hand 36 and the second hand 38, outputting the detected results to the timepiece controller 50. The hand position detector 60 has, for example, a light emitting device and a light receiving device. A light emitting surface of the light emitting device and a light receiving surface of the light receiving device are arranged so as to face each other with a gear having a position detecting hole interposed therebetween. The hand position detector 60 detects the position of the timepiece hand based on light emitted from the light emitting device received by the light receiving device. It is also possible that the hand position detector 60 also acquires the drive pulse generated by the motor drive circuit 54 and detects the positions of each timepiece hand based on the detected drive pulse.

The display unit 80 includes the display unit communication section 82, a display unit controller 84, a display drive section 86, an operation display section 88 and an operation detector 89. The display unit communication section 82 can communicate with the display communication section 20 of the information unit 10. The display unit controller 84 outputs a display control signal for controlling the display drive section 86 based on the signal acquired from the display unit communication section 82. The display drive section 86 controls the operation display section 88 based on the display control signal.

The operation display section 88 is a display device such as a LCD (Liquid Crystal Display) and an organic EL (Electroluminescence) display. The operation display section 88 is, for example, a transparent LCD, through which the superimposed display dial 32, timepiece hands and so on in the electronic timepiece unit 30 can be seen when the control signal is not outputted from the display unit controller 84. The operation display section 88 displays an image corresponding to a signal transmitted from the information unit 10, the GUI switches for the operation and so on under the control by the display drive section 86. The operation detector 89 is provided by being superimposed on the operation display section 88. The operation detector 89 detects a position touched by the operator in the operation display section 88 by a coordinate detection mechanism and transmits the detected result to the information unit 10 through the display unit communication section 82. The operation detector 89 generates an operation signal corresponding to an operation when detecting a flick operation, a swipe operation and so on with respect to the GUI and outputs the signal to the display unit controller 84. The signal transmitted to the information unit 10 through the display unit communication section 82 as the detected result can be also processed as the operation input from the information operation section 24 by a not-shown route.

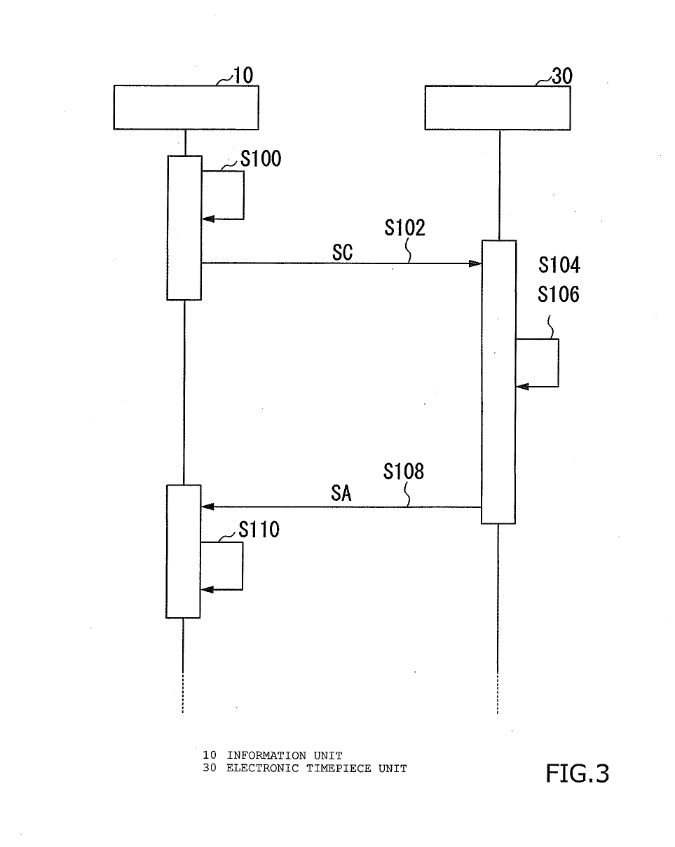

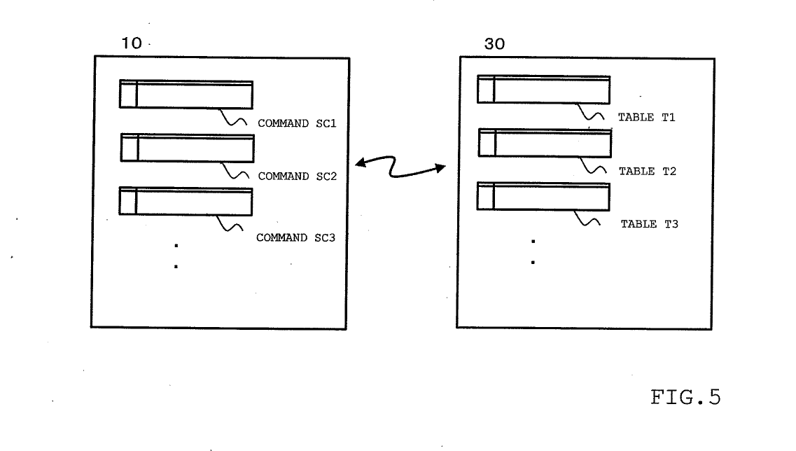

FIG. 3 is a sequence diagram showing the flow of processing executed by the electronic timepiece system 1. FIG. 5 is a diagram showing commands stored in the information unit 10 and motor control setting tables stored in the electronic timepiece unit 30.

First, the signal controller 27 of the information unit 10 selects a command for controlling the timepiece hands of the electronic timepiece 30 (Step S100). For example, any of plural commands SC1 to SC3 of FIG. 5 is selected. The command may be generated inside as well as inputted from the outside. The signal controller 27 of the information unit 10 outputs the command SC to the electronic timepiece unit 30 through the communication section 18 (Step S102). For example, when an operation input is performed by the user with respect to the operation display section 88 of the display unit 80, the signal controller 27 selects the command. The command is, for example, a signal for controlling the time hands regardless of the time, including identification information of a later-described motor control setting table in the command. The command may also include simple control information such as the number of times of repeating an operation relating to a control program of controlling the motors based on the motor control setting table.

Next, the timepiece controller 50 of the electronic timepiece unit 30 acquires the command SC through the communication section 48 and reads the motor control setting table corresponding to the acquired command SC from the storage section 44 to drive the motors (Step S104, S106). As shown in FIG. 5, plural motor control setting tables are stored in the storage section 44, and a desired table T is selected in accordance with identification information included in the command SC acquired through the communication section 48.

FIG. 6 shows a format of a table T1 (first motor control setting table) as an example of the motor control setting table of the motor which drives hands including the minute hand and soon. The tables T are provided for respective plural commands. Here, the motor control setting table is information for instructing, for example, a continuous operation of timepiece hands. For example, information for controlling the hands 34, 36 and 38 and so on is stored for respective slots prescribing the operation timing. In this case, the timepiece controller 50 operates the hand by controlling the hand drive section 52 based on information stored in the slots 1 to N as shown in the drawing. The information stored in the slots are, for example, control items of timepiece hands, such as the controlled hand indicating hands to be controlled, the hand drive frequency (speed), the rotation direction of timepiece hands, the drive counter indicating the drive targets of the hands (rotation angles of timepiece hands) driven by processing of one slot, the position where the operation of timepiece hands is started, the interval indicating the time until next processing is started, the slot number designating the slot to be processed next. Physical quantities corresponding to these control items are respectively designated.

Next, the setting of control items of the table T1 will be explained. The control item as the “controlled hand” indicates the hand number to be controlled. In this case, the “hour hand”, the “minute hand”, the “second hand” and a “small hand” are designated as physical quantities. The small hand is embodied as a later-described “small hand” 64 according to a second embodiment. In the control item as the “start position”, values of a counter indicating the start positions of the hands are set. The angle of the start position is set by setting one counter as 1.5 degrees and setting a position of 12 o'clock as 0 (zero) degrees. For example, when the count value is “120”, the angle of 180 degrees (a direction of 6 o'clock) is indicated. As count values, “0” to “239” which mean 0 (zero) degrees to 358.5 degrees and a “current position” which means a position where the hands currently exist are set. That is, occasions where the current position is designated include a case where the hand positions detected by the hand position detector 60 are not considered, a case where the detection itself is not performed and a case where the hand position detector is not mounted.

In the control item as the “drive frequency”, “16”, “32”, “64”, “128” and so on can be set as values. The unit is “Hz”. It is possible to set the value as “highest”. In that case, the value of the drive frequency is not fixed and is the highest speed which can be set in the electronic timepiece unit 30 in consideration of the motors 56, the wheel hands 58 and so on. The control item as the “drive counter” is the item which can be effective only when the start position is designated as the “current position”. The motor 56 can be driven within a range of steps 1 to 240 to move the hands. The driving of one step by the motor corresponds to an operation angle 1.5 degrees of the hand. For example, the hand can be moved by 6 degrees by four steps. For example, when “30” is set in the drive counter, the value means that a target rotation angle is 45 degrees. In the control item as the “rotation direction”, a forward rotation (right-handed rotation) is set as “forward”, a reverse rotation (left-handed rotation) is set as “reverse”, and “forward and, reverse” can be designated when it is desired to be set in a direction where the value of the drive counter (target rotation angle) is small.

The control item as the “interval” indicates the time until processing of the next slot is started. For example, when the interval is set to “10” in the case where the sampling frequency is 10 Hz, processing of the next slot is started after one second passes as ( 1/10)×10 counts=1 second. The control item as the “next slot number” indicates the slot number to be processed next. For example, while the slot 1 is processed, “1” can be designated when the same slot 1 is continuously executed, and “2” can be designated when the slot 2 which is the next slot is executed.

As described above, the control items corresponding to characteristics of the motors which drive the hands of the timepiece are set in the motor control setting table T. Accordingly, the control considering motor characteristics can be added to the movement of the hands requested by the command SC acquired through the communication section 48. Accordingly, the information unit 10 on the side of transmitting the command SC can control the hands of the electronic timepiece unit 30 to perform desired movement without necessity of creating the command based on the detailed characteristics of the motors of the electronic timepiece unit 20.

The motor control setting tables may be stored in the storage section 44 in advance, or may be stored or updated by being acquired through the communication section 48. The acquisition and the update of the motor control setting table are executed by the timepiece controller 50 based on the operation input of the operation section 47 of the electronic timepiece unit 30 or signals transmitted from the information unit 10 or other information devices.

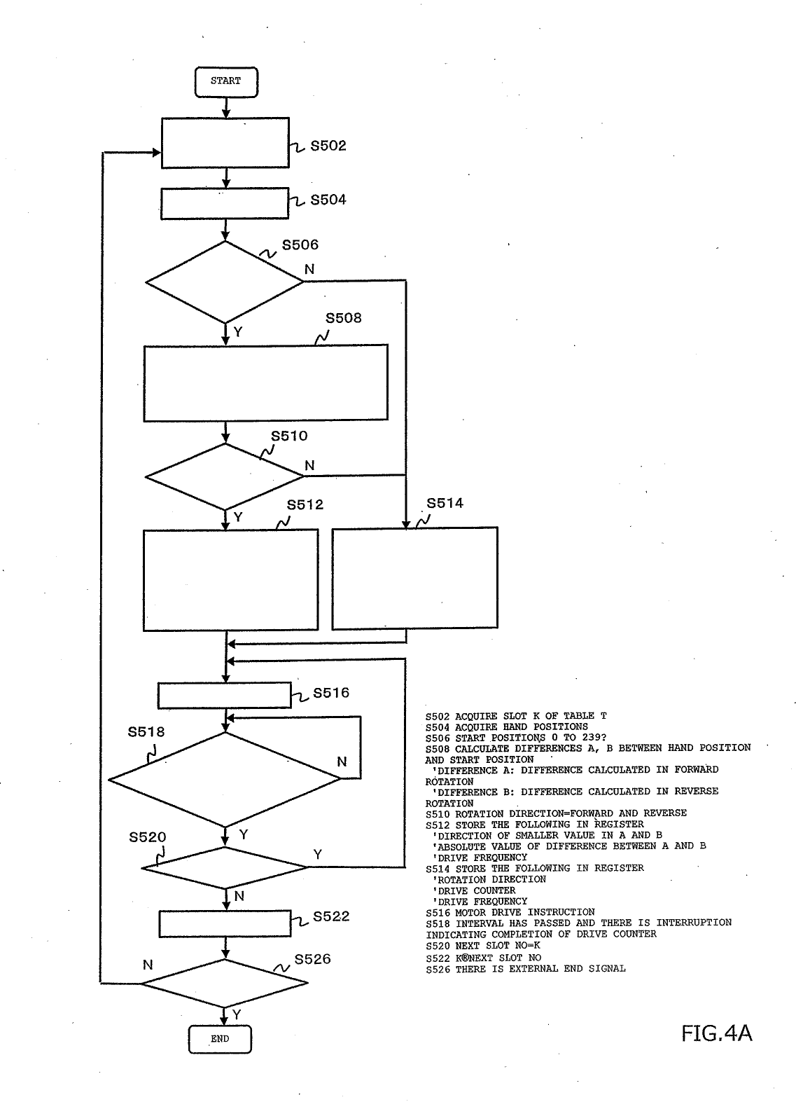

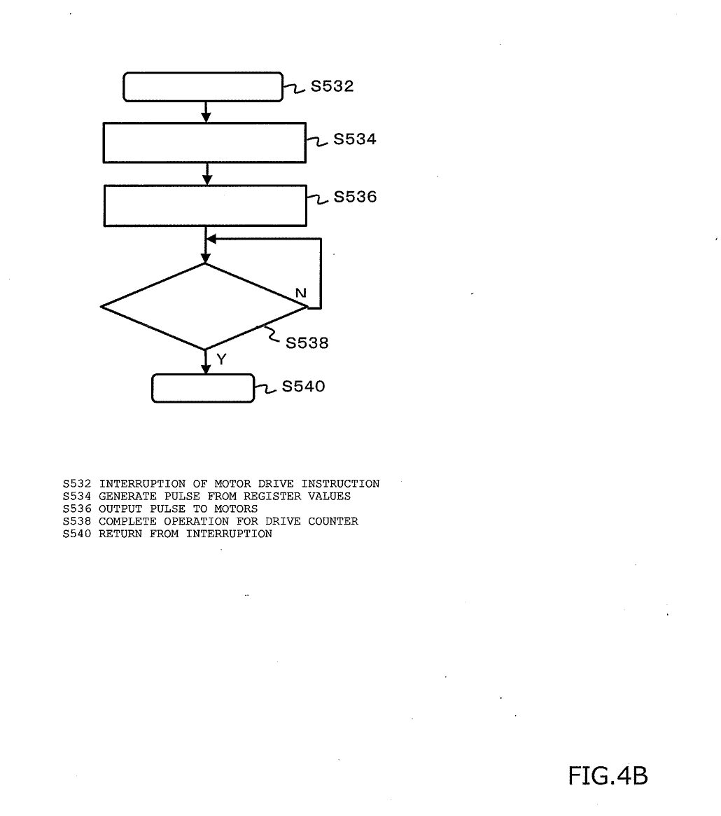

Next, the details of Step S104 and S106 processed in the electronic timepiece unit 30 will be explained based on FIG. 4 and FIG. 6. FIG. 4 shows a processing flow for realizing the movement of the hands in accordance with motor characteristics based on the motor control setting table selected by the command.

In this case, the control of operating the hands (36 and so on) of the electronic timepiece unit 30 in accordance with the notification content (for example, a receiving notification of an e-mail) from the information unit 10 as the smartwatch so that the user can visually recognize the hands will be explained.

Referring to FIG. 4A, the timepiece controller 50 of the electronic timepiece unit 30 reads the motor control setting table T1 (hereinafter, the table T1) corresponding to the command SC1 (first command) received in Step S102 from the storage section 44 and acquires values of control items in the slot “0” (Step S502). Next, values of hand positions of the hands 34, 36 and 38 are acquired (S504). Step S504 may be performed before Step S502. Consequently, target start positions of respective hands are read (Step S506). When the target values are not the “current position”, the process proceeds to Step S510 (Y of S506) and when the values are the “current position”, the process proceeds to Step S514 (N of S506). As target positions in the slot “0”, the hour hand is moved to a position of 270 degrees (9 o'clock), the minute hand is moved to a position of 90 degrees (3 o'clock) and the second hand is moved to a position of 0 degrees (12 o'clock).

In Step S508, the difference between the hand position and the target start position is calculated. The difference calculated in the forward rotation is a difference A and the difference calculated in the reverse rotation is a difference B. Next, whether the designation of the rotation direction is “forward and reverse” or not is determined (Step S510). When the designation is “forward and reverse” (Y of S510), the process proceeds to Step S512, where a smaller value in the absolute value of the difference A and the absolute value of the difference B, the rotation direction and the drive frequency are written in a register of the motor drive circuit 54. When the designation in the rotation direction is “forward rotation” or “reverse rotation” (N in S510), the process proceeds to Step S514, where the designated rotation direction, the value of the drive counter and the drive frequency are written in the register of the motor drive circuit 54. Also in the case where the start position is designated as the “current position” in Step S506, the process also proceeds to the Step S514, where these data is written in the register.

Next, a drive instruction is made with respect to the motor drive circuit 54 (Step S516). The motor drive circuit 54 drives motors corresponding to respective hands based on data written in the register in accordance with interruption of the drive instruction (Step S532).

In FIG. 4B, the motor drive circuit 54 receiving the interruption instruction generates the drive pulse for driving stepping motors in accordance with the values in the register (Step S534). Next, the drive pulse is outputted to the motors (Step S536). Next, when the pulse output for the drive counter designated in the slot “0” is completed (Step S538), the process returns from the interruption (Step S540).

When the timepiece controller 50 confirms that the interval time designated by the item of the interval has passed and that the return from interruption has been received (Step S518), the process proceeds to Step S520. In Step S520, whether the value of the next slot number is the same as the slot number currently processed or not is confirmed. When the value is the same (Y of S520), the process returns to Step S516, where the motor drive circuit 54 executes the same driving again by executing the motor drive instruction. In the slot “0” of FIG. 6, “1” is designated as the next slot number, therefore, the process proceeds to the control item of the slot 1.

In Step S526, whether there is a processing end signal from the outside or not is determined, and when there is an external signal, the process ends (Y of Step S526). The processing end signal from the outside may be a signal based on the input from the operation section 47 of the electronic timepiece unit 30 or the input from the information operation section 24 of the information unit 10 and so on. In the case of N in Step S526, the process continues and the processing corresponding to the control item of the slot number as the next slot Number is started (Step S502).

As described above, the electronic timepiece unit 30 receiving the command SC is capable of controlling the driving of the timepiece hands corresponding to motor characteristics by referring to the table T1 included inside. In this case, it is not necessary that the information unit 10 knows motor characteristics.

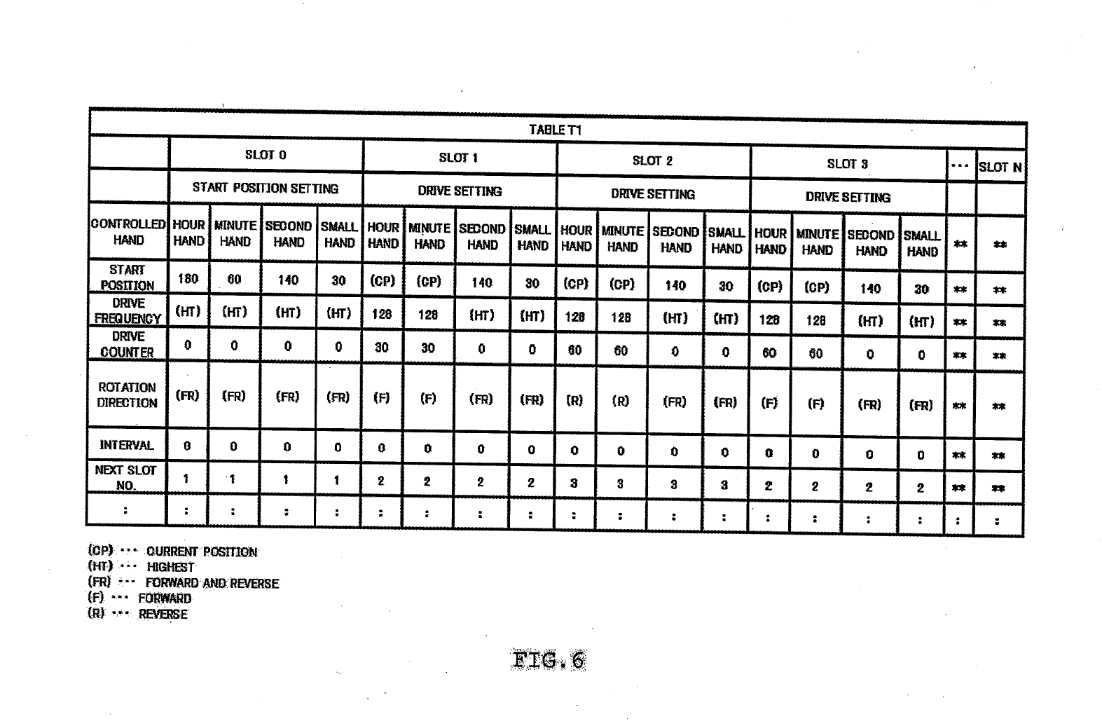

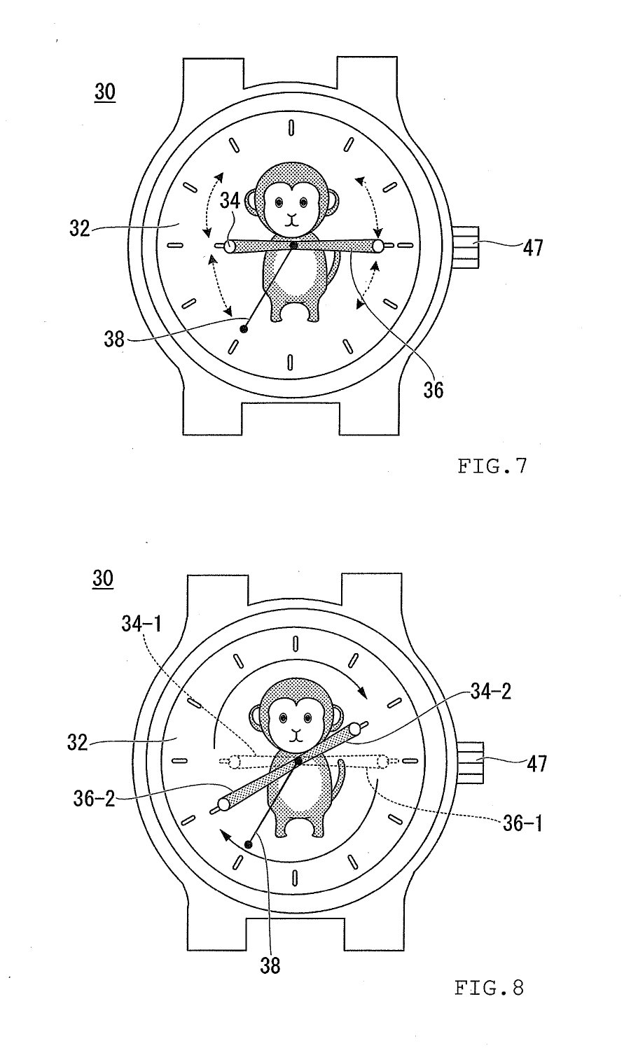

After that, the driving of the timepiece hands are controlled in accordance with the control items in Table T1 in the same manner. After the hour hand 34 is moved in 9 o'clock direction and the minute hand 36 is moved in 3 o'clock in the horizontal straight line (180 degrees) under the control based on the slot “0”, the hour hand 34 is moved in 10:30 direction and the minute hand 36 is moved in 4:30 direction under the control based on the slot 1. That is, the operation in which the hour hand and the minute hand lean to the right is performed in the state of the straight line. At that time, the second hand 38 is continuously directed in 7 o'clock direction. Next, the hour hand 34 is moved in 7:30 direction and the minute hand 36 is moved in 1:30 direction under the control based on the slot 2. That is, the operation in which the hour hand and the minute hand lean to the left is performed in the state of the straight line. Next, the hour hand 34 is moved in 10:30 direction and the minute hand 36 is moved in 4:30 direction under the control based on the slot 3. That is, the operation in which the hour hand and the minute hand lean to the right is performed in the state of the straight line. Here, “2” is designated as the next slot number of the slot 3, therefore, the control is performed next based on the slot 2. As the control of the slot 2 and the control of the slot 3 are repeated, the operation in which the hour hand and the minute hand swing right and left is continued, which can allow the user who wears the electronic timepiece system 1 to visually recognize the reception of the e-mail. For example, the operation is performed as shown in FIG. 7. The small hand is not shown in FIG. 7.

Next, the timepiece controller 50 transmits a control completion signal SA indicating that the control relating to the command has been completed to the information unit 10 when the corresponding control is completed (Step S108). Next, the information unit 10 acquires the control completion signal SA (Step S110). The processing executed by the electronic timepiece system 1 ends by the above processing.

The timepiece controller 50 may acquire plural commands at a time, or may acquire another command while performing control corresponding to the acquired command. In this case, it is also possible to store the acquired command in the storage section 44 and sequentially read commands stored in the storage section 44 to execute control corresponding to the commands. That is, buffer processing is executed.

A case where the timepiece hands of the electronic timepiece unit 30 operate based on the command transmitted from the information unit 10 is shown as examples with reference to FIG. 8 to FIG. 13. The information unit 10 can suitably select the commands SC corresponding to the following operations from the plural commands SC. The electronic timepiece unit 30 executes, instead of the above operations of the timepiece hands or in addition to the above operations, for example, a rotating operation, an opening operation, an operation of returning to original positions, an operation of gathering at one point, a stopwatch operation, a count-down timer operation and an operation of being the time. In the following explanation, the table T2 (the second motor control setting table) is used only in the count-down timer operation as the motor control setting table T, however, also in other operations, the tables T (which can be the second motor control setting tables by the same manner as the Table T1) are created and stored in the storage section of the electronic timepiece unit 30. The reason why the motor control setting tables are written as “the first” and “the second” is for indicating that plural Tables T can be stored, which does not limit the contents of Tables.

### (Rotating Operation)

The rotating operation is an operation in which the timepiece hands rotate based on a control program. FIG. 8 is a view for explaining the rotating operation. The control program stores control information such as a speed at which the timepiece hands rotate, a direction and the number of rotations. When the rotating operation is performed, the timepiece controller 50 controls the timepiece hands based on the control program. Accordingly, a shown hour hand 34-1 before being controlled is controlled to rotate, for example, in the right direction like an hour hand 34-2 a given number of times. A shown minute hand 36-1 before being controlled is controlled to rotate for example, in the right direction like a minute hand 36-2 a given number of times.

### (Opening Operation)

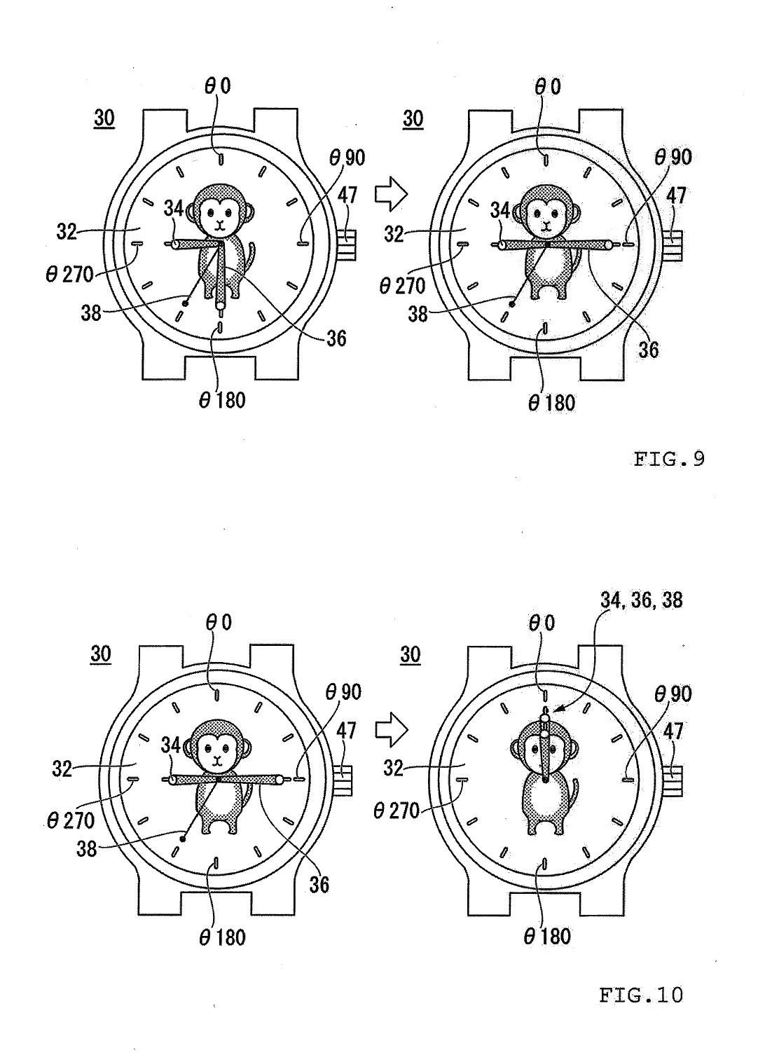

The opening operation is an operation in which the timepiece hands open at 180 degrees based on a control program. FIG. 9 is a view for explaining the opening operation. In the drawing, θ=0 to θ=270 indicate an angle “0” (360) degrees, 90 degrees, 180 degrees and 270 degrees, respectively. The control program stores control information such as a rotating speed at which the timepiece hands open and a direction thereof. The control program also stores control information in which the timepiece controller 50 detects current positions of the timepiece hands and moves the timepiece hands from the detected position to positions where the hour hand 34 and the minute hand 36 open (straight line). For example, when the minute hand 36 positioned at θ=180 degrees as shown in the left drawing rotates to a position of θ=90 degrees as shown in the right drawing, thereby operating the hour hand 34 and the minute hand 36 to open at 180 degrees.

### (Operation of Returning to Original Positions)

The operation of returning to original positions is an operation in which, for example, the timepiece hands return to original positions based on a control program. The control program stores control information such as a speed at which the timepiece hands return to original positions and a direction thereof. The control program also includes control information for controlling the timepiece hands to return to original positions by referring to original positions stored in the storage section 44. Accordingly, the minute hand 36 positioned at θ=90 degrees shown in the right drawing of FIG. 9 returns to a position of θ=180 degrees as an original position shown in the left drawing by executing the operation of returning to the original position.

### (Operation of Gathering at One Point)

The operation of gathering at one point is an operation in which, for example, the timepiece hands gather at one point based on a control program. FIG. 10 is a view for explaining the operation of gathering at one point. The control program stores control information such as a speed at which the timepiece hands gather at one point, a direction and gathering positions thereof. Accordingly, the hour hand 34, the minute hand 36 and the second hand 38 existing at different positions, for example, as shown in the left drawing gather at a position of θ=0 degrees as shown in the right drawing.

### (Stopwatch Operation)

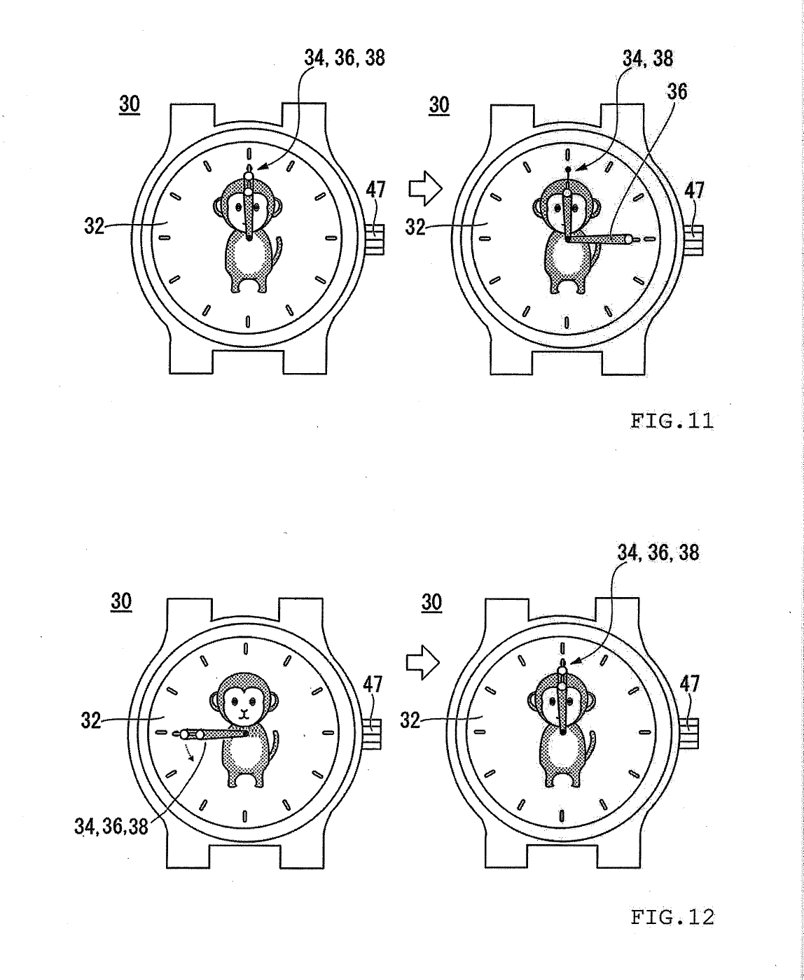

The stopwatch operation is an operation in which, for example, the timepiece hands count the time based on a control program. FIG. 11 is a view for explaining the stopwatch operation. The control program stores control information for gathering the timepiece hands at given positions first, then, starting a given rotation of the timepiece hands when a count start signal is inputted and stopping the rotating timepiece hands when a count stop signal is inputted. Accordingly, for example, the timepiece hands gather at θ degrees as shown in the left drawing, then, when the count end signal is inputted, the timepiece hands rotate so as to correspond to the time lapse and, when the count end signal is inputted, the timepiece hands stop at a position of θ=90 degrees corresponding to the inputted count stop signal as shown in the right drawing.

The count start signal and the count stop signal may be acquired through the communication section 48 of the electronic timepiece unit 30, or may be inputted by the operation of the operation signal 47. The count start signal is, for example, a signal inputted first after the timepiece hands gather at the position of θ=0 degrees by the stopwatch operation, and the count stop signal is a signal inputted after the count start signal is inputted.

### (Count-Down Timer Operation)

The count-down timer operation is an operation of counting a remaining time to a target value based on a control program. FIG. 12 is a view for explaining the count-down timer operation. The control program stores control information for gathering the timepiece hands at the timer start position, then, starting the rotation of the timepiece hands corresponding to a case where a timer start signal is inputted and stopping the operation when the timepiece hands return to the timer start position. Accordingly, for example, the timepiece hands gather at θ degrees as the timer start position as shown in the left drawing, then, the timepiece hands rotate to the left so as to correspond the time lapse when the timer start signal is inputted, and the operation stops when the timepiece hands return to the timer start position θ=0 degrees as shown in the right drawing. The timer start signal may be acquired through the communication section 48 of the electronic timepiece unit 30, or may be inputted by the operation of the operation signal 47 in the same manner as the stopwatch operation. That is, the timepiece controller 50 may perform different types of control corresponding to signals inputted by the user's operation in accordance with the types of control programs.

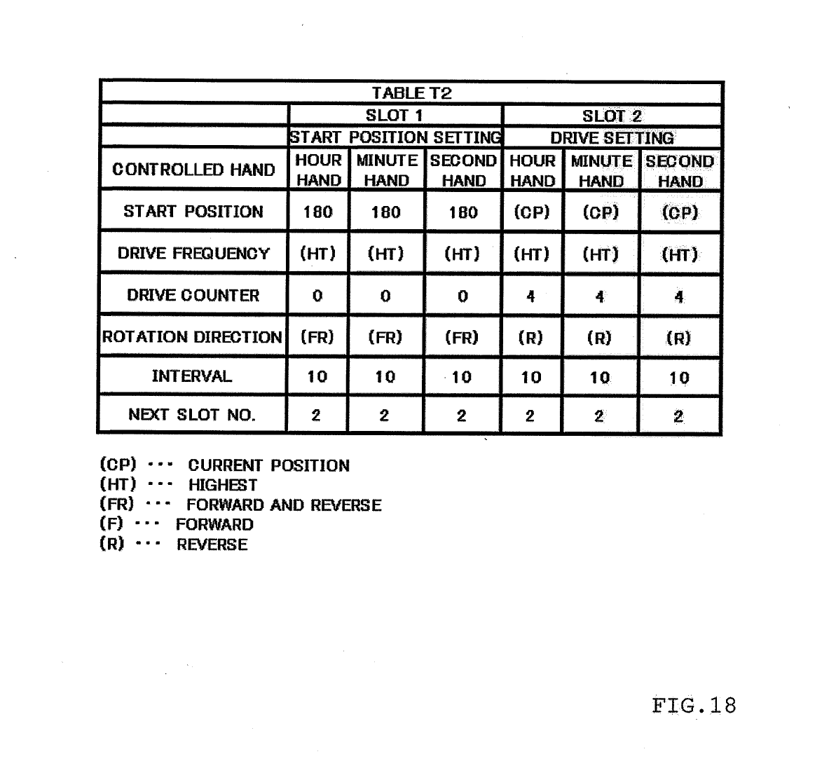

FIG. 18 is a view for explaining a motor control setting table (table T2) in an example of the count-down timer. The information unit 10 transmits the command SC2 (second command) including variables concerning the “count-down timer” and the “time to be counted down” from plural commands SC through the communication section 18 (Step S102). The content of the command SC2 in this case is to execute a count-down timer of 45 seconds. The communication section 48 of the electronic timepiece unit 30 receives the command SC2. The electronic timepiece unit 30 reads the table T2 corresponding to the command SC2 for the count-down timer as shown in FIG. 18 from the storage section 44 (Step S104). After that, the processing is executed based on the processing flow of FIG. 4.

In FIG. 18, hands to be controlled are the hour hand, the minute hand and the second hand in the slot 1 for setting the start position. The start position is a position of 270 degrees. The drive frequency is the highest speed which can be set in the electronic timepiece unit 30 considering the motors 56, the wheel hands 58 and so on. The drive counter is not set. For example, when the detection result by the hand position detector 60 is a position of 240 degrees (8 o'clock in the hour hand, 40 minute in the minute hand and 40 seconds in the second hand), the rotation direction is 30 degrees in the forward rotation (20 counts) and 330 degrees in the reverse rotation (220 counts), therefore, the forward rotation which is the direction where the value of the drive counter is small is designated. As the interval, “1” (10 counts in 10 Hz) is designated.

According to the setting of the above, the motors 56 are driven to stop the hour hand 34 at a position of 9 o'clock (270 degrees), the minute hand 36 at a position of 45 minutes (270 degrees) and the second hand 38 at a position of 45 seconds (270 degrees) in an overlapping state.

Here, as “2” is designated as the next slot number, the processing of the slot 2 as the next slot is executed after the processing of the slot 1 is completed. At this time, one second is designated as an interval to the next processing, therefore, the processing based on the slot 2 is executed after one second passes.

Control items of the slot 2 which are different from control items of the slot 1 are, the start position, the drive counter and the rotation direction. The start position is not designated as the detected results of the hand position detectors are not considered. The drive counter is set to “4”, and 6 degrees as the movement of the hand, namely, one second is designated. The reverse direction is designated as the rotation direction. Accordingly, the registers of the motors are set and the motors are driven. As “2” is designated as the next slot number, the driving is repeated. Therefore, the count-down timer operation is possible so that the hour hand 34, the minute hand 36 and the second hand 38 are reversely rotated in the same behavior by 6 degrees per second.

### (Operation of Being Time)

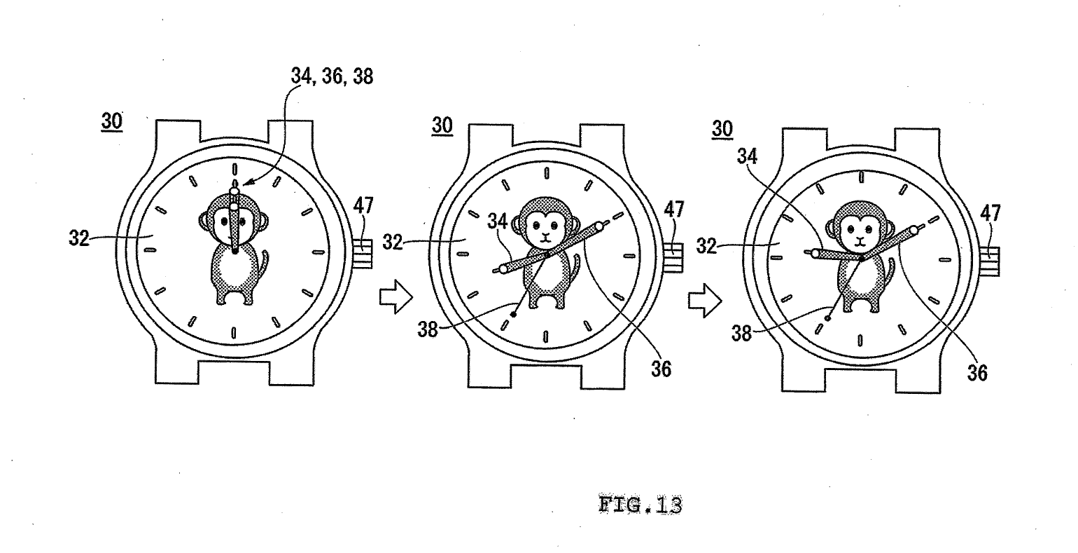

The operation of being the time is an operation in which the timepiece hands display the time based on a control program. FIG. 13 is a view for explaining the operation of being the time. The control program stores control information for controlling the timepiece hands to correspond to time information updated by the timepiece controller 50. Accordingly, the timepiece hands are controlled so as to point to a time 8:10 as shown in the middle drawing from the initial position (0:00 in the left drawing). Moreover, a control program storing that the time hands are put forward one hour is executed, the timepiece hands are controlled to be put forward one hour and to point to 9:10 as shown in the right drawing (the operation of putting the time forward one hour).

As described above, the electronic timepiece unit 30 controls the operation of the timepiece hands by using the motor control setting table based on the command acquired from the information unit 10. Therefore, the information unit 10 can operate hands of the electronic timepiece with rich variations only by selecting or setting the command. The user wearing the information unit 10 can instinctively know the notification contents by visually recognizing the variable movements of hands.

Here, the commands can be associated with, for example, information stored in the information unit 10. The commands are, for example, the intensity of communication radio waves, the receiving result of an e-mail, the existence of an incoming call and so on. The timepiece hands of the electronic timepiece unit 30 operate based on the transmitted command, thereby expressing information held by the information unit 10 by using the timepiece hands. The user recognizes, for example, association between the operation of the timepiece hands and information expressed by the operation in advance, therefore, the user can recognize information by the operation of the timepiece hands.

In the first embodiment explained as the above, the timepiece controller 50 can control the timepiece hands more freely based on the command for controlling the timepiece hands regardless of the time acquired through the communication section 48 and can operate the timepiece with rich expression.

### Second Embodiment

Hereinafter, the second embodiment will be explained. Here, the explanation will be made focusing on points different from the first embodiment, and explanation of functions and so on common to the first embodiment is omitted. In the second embodiment, the electronic timepiece unit 30 requests the information unit 10 to send a command.

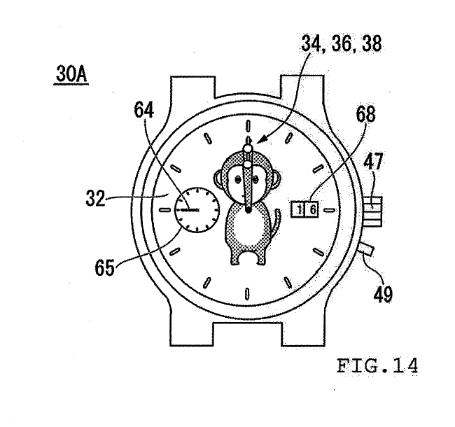

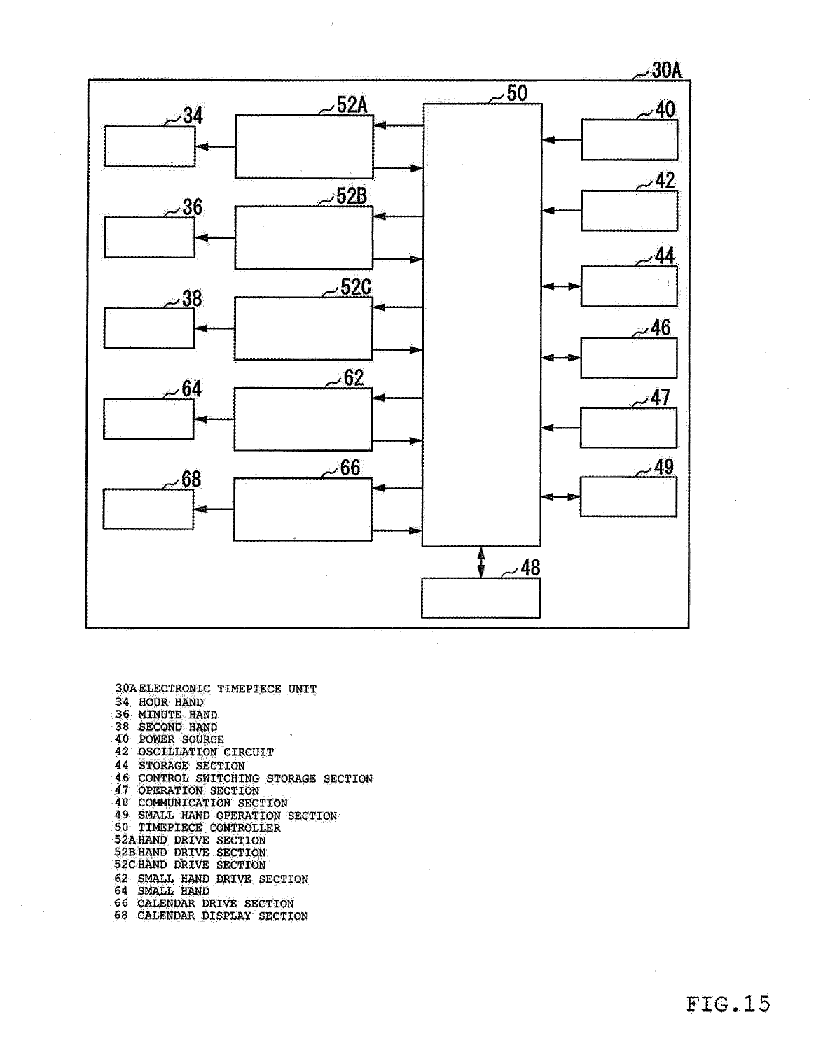

FIG. 14 is an appearance view of an electronic timepiece unit 30A. FIG. 15 is a functional configuration diagram of the electronic timepiece unit 30A. The electronic timepiece unit 30A includes a small hand operation section 49, a small hand drive section 62, a small hand 64, a small hand display section 65, a calendar drive section 66 and a calendar display section 68 in addition to the functional configuration of the electronic timepiece unit 30 according to the first embodiment. The small hand operation section 49 is an operation section to which an instruction for driving the small hand drive section 62 is inputted. For example, when the small hand operation section 49 is pressed, the small hand drive section 62 is driven and the small hand 64 is driven. The small hand operation section 62 and the small hand 64 function as a chronograph mechanism. The calendar display section 68 operates by the drive of the calendar drive section 66 to display a date.

The small hand drive section 62 and the calendar drive section 66 respectively have the motor drive circuit, the motor, the wheel hand and the hand position detector in the same manner as the hand drive sections 52. As these functions have the same as the functions explained in the first embodiment, the explanation and the drawing are omitted. Note that the calendar drive section 66 has a display section position detector instead of the hand position detector. The driving of the small hand drive section 62 and the calendar drive section 66 is controlled by the control of the timepiece controller 50.

The storage section 44 stores a program for requesting the information unit 10 to transmit a command for executing the control program based on given conditions. In the control program, physical quantities for operating the timepiece hands, the calendar display section 68 or the small hand 64 are associated. The electronic timepiece unit 30 may also request the transmission of the command by operating an installed application program. In this case, the storage section 44 stores installed application programs acquired through the communication section 48, or the API (Application Programming Interface).

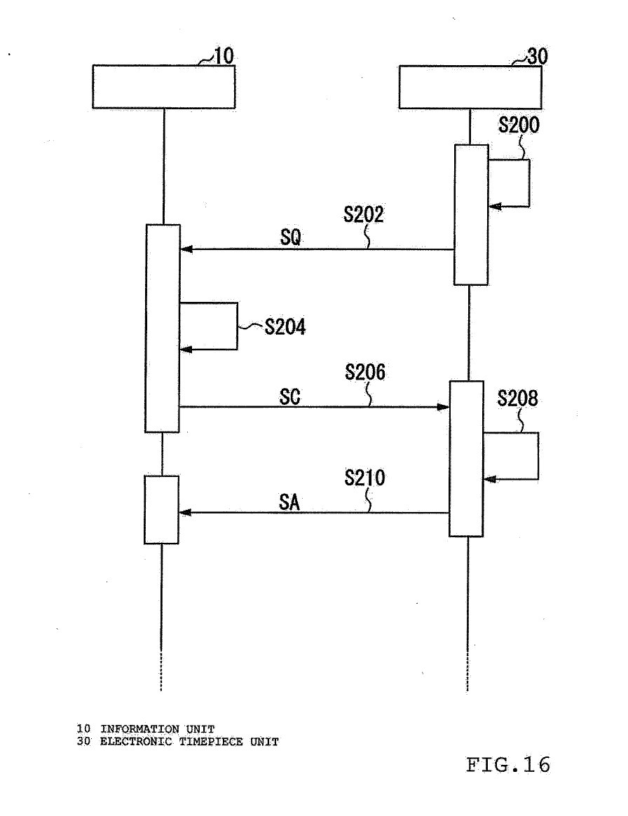

FIG. 16 is a sequence diagram showing the flow of processing executed by the electronic timepiece system 1 according to the second embodiment. First, the timepiece controller 50 of the electronic timepiece unit 30 generates a request signal SQ requesting the information unit 10 to transmit a command (Step S200) and transmits the generated request signal SQ to the information unit 10 (Step S202). The request signal SQ is generated, for example, when the timepiece controller 50 detects that the small hand operation section 49 has been pushed and operated. The timepiece controller 50 may generated at time intervals which are previously set based on the program stored in the storage section 44.

Next, the information controller 25 of the information unit 10 acquires the request signal SQ through the communication section 18, generating a command SC corresponding to the acquired request signal SQ (Step S204) and transmitting the command to the electronic timepiece unit 30 (Step S206). In the generation of the command, commands corresponding to request signals may be previously associated, or random numbers may be generated and the commands corresponding to the random numbers may be transmitted by an operation input by the user with respect to the application program.

Next, the timepiece controller 50 of the electronic timepiece unit 30 performs control stored in the control program based on the acquired command SC (Step S208). For example, when the command SC corresponds to the control program based on a table relating to the rotating operation, one or more of the timepiece hands, the small hand 64 and the calendar display section 68 rotate based on the control program.

Next, when the execution of the control program is completed, the timepiece controller 50 transmits a notification SA indicating the completion of the control program to the information controller 25 of the information unit 10 (Step S210). Accordingly, the processing executed by the electronic timepiece system 1 ends.

Although the case where the rotating operation is performed by the control program has been explained in the embodiment, the operations of the first embodiment may be executed. The operations of the timepiece hands, the small hand 64 and the calendar display section 68 may be stored in the information unit 10 or may be stored in different manners according to acquired information. In this case, the information unit 10 previously stores tables with association which store correspondence relation between information and commands. For example, when the information unit 10 desires to inform the reception of an e-mail, the information unit 10 transmits a command corresponding to the reception of the e-mail to the electronic timepiece unit. Accordingly, the timepiece hands of the electronic timepiece unit 30 execute the operation corresponding to the reception of the e-mail. As the user previously knows the correspondence relation between the operation of the timepiece hands and information stored in the information unit 10, the user can recognize information stored in the information unit 10 by the operation of the timepiece hands.

The electronic timepiece unit 30 according to the second embodiment described above transmits the request signal for requesting the transmission of the command to the information unit 10 and receives the command corresponding to the request signal from the information unit 10 to execute the control program corresponding to the received command, therefore, the timepiece hands of the device itself can be voluntarily controlled.

### Third Embodiment

Hereinafter, a third embodiment will be explained. Here, the explanation will be made focusing on points different from the first embodiment, and explanation of functions and so on common to the first embodiment is omitted. In the third embodiment, the electronic timepiece unit 30 acquires a command transmitted from other devices such as a smartphone 90 and a base station 92 through the information unit 10 and controls the timepiece hands so as to respond to the acquired command.

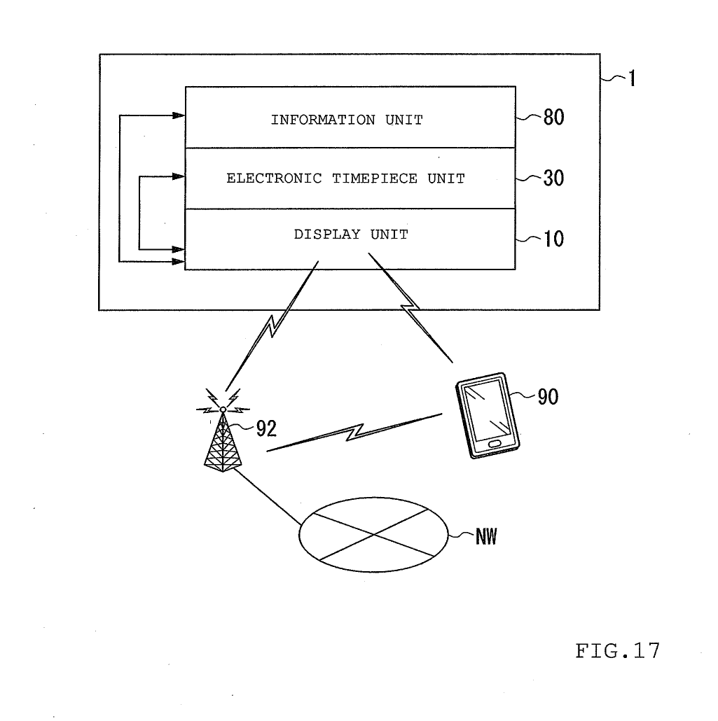

FIG. 17 is a view for explaining a case of acquiring the command from the external device and so on. The base station 92 is connected to, for example, a network NW through a wire, which can communicate with other base stations connected to the network NW and terminal devices. The smartphone 90 can communicate with the base station 92 and the electronic timepiece system 1 by wireless communication. The smartphone 90 and the electronic timepiece system 1 communicate with each other by using communication standards such as Bluetooth (registered standard). When a command is transmitted to the smartphone 90 to the electronic timepiece system 1, the electronic timepiece unit 30 acquires the command transmitted from the smartphone 90 through the information unit 10 and executes the control program based on the table corresponding to the acquired command to thereby operate the timepiece hands.

The electronic timepiece system 1 according to the third embodiment described above acquires the command from other devices and controls the timepiece hands based on the acquired command, therefore, the versatility can be improved.

The explanation has been made on the assumption that the display unit is included in the above embodiments, however, the display unit 80 may be omitted. Moreover, the explanation has been made on the assumption that the display unit 80 is provided on an upper surface of the electronic timepiece unit 30, however, it is also possible to stack the information unit 10, the display unit 80 and the electronic timepiece unit 30 in this order. In this case, a casing outer surface possessed by the electronic timepiece unit 30 is formed in a skeleton structure, which allows the user to visually recognize information displayed by the display unit 80. Furthermore, the explanation has been made on the assumption that the electronic timepiece system 1 stacks the information unit 10 and the electronic timepiece unit 30 as an example, however, it is also possible to have the information unit 10 and the electronic timepiece unit 30 without stacking the information unit 10 and the electronic timepiece unit 30. It is also possible to stack the electronic timepiece unit 30, the information controller 25 and the communication section 18, or to have the electronic timepiece unit 30, the information controller 25 and the communication 18 without stacking them. In the case where the electronic timepiece unit 30, the information controller 25 and the communication section 18 are stacked, the information controller 25 and the communication section 18 are stacked on the electronic timepiece unit 30 so that the display dial 32 and the timepiece hands of the electronic timepiece unit 30 can be visually recognized by the user. For example, they can be stacked on a side surface of the electronic timepiece unit 30 or part of a surface of the display dial 32 side.

It is also possible to operate the timepiece hands to dance to music by executing a control program. When a command corresponding to the music selected by the user is acquired from the information unit 10, the smartphone 90, a karaoke machine having a communication function, the timepiece hands operate so as to dance by executing the control program corresponding to the command. It is also possible to operate the timepiece hands so as to show the tempo of the music like a metronome instead of the dancing motion of the timepiece hands.

In the third embodiment explained as the above, the timepiece controller 50 controls the timepiece hands so as to also response to commands generated by other devices and so on, which further improves the convenience of the user.

The embodiments of the present invention have been explained as the above, and the present invention is not limited to the above embodiments and various modification may occur within a range not departing from the gist of the present invention. For example, the embodiments can be combined with one another.

For example, it is possible to adopt an embodiment in which the first embodiment is combined with the second embodiment, an embodiment in which the first embodiment is combined with the third embodiment, an embodiment in which the first embodiment, the second embodiment and the third embodiment are combined to one another. Furthermore, it is possible to control hands so as to display the time by the command and the motor control setting table. That is, the electronic timepiece system has the time function, however, the operation of hands not relating to the time can be controlled by the command. The command SC can be set with respect to each slot. That is, the “next slot number” of each table T is deleted and plural tables including control items other than that item are prepared, and that the command corresponding to each table is transmitted from the information unit 10 to the electronic timepiece unit 30.

It is also preferable that the operation section 47 is provided, for example, in the information unit 10. The operation section 47 may be removed. The electronic timepiece unit 30 can be reduced in size accordingly.

What is claimed is:

1. An electronic timepiece comprising:
hands driven to be rotated along a display dial;
a drive section driving the hands;
an acquisition section acquiring a command for controlling the hands regardless of the time; and
a controller outputting a control signal for controlling the drive section based on the command acquired by the acquisition section.

2. The electronic timepiece according to claim 1,
wherein the drive section is a stepping motor operating based on a pulse,
a storage section storing correspondence relation between the command and physical quantities corresponding to control items of the stepping motor is included, and
the controller controls the stepping motor based on the obtained physical quantities by referring to the correspondence relation stored in the storage section by using the command acquired by the acquisition section.

3. The electronic timepiece according to claim 2,
wherein the control items include items concerning the hands to be controlled, the number of steps of the stepping motor corresponding to target angles of hands to be driven, the rotation direction of hands and the rotation speed of hands.

4. The electronic timepiece according to claim 3, further comprising:
a hand position detector which can be detect current angles of the hands by detecting positions of hands,
wherein physical quantities corresponding to the control items include physical quantities based on the difference obtained by comparing the target angle to be driven with the current angle.

5. The electronic timepiece according to claim 1,
wherein the acquisition section can acquire at least one of a first command and a second command as the command, and
the storage section stores at least a first motor control setting table corresponding to the first command and a second motor control setting table corresponding to the second command as the correspondence relation.

6. The electronic timepiece according to claim 1,
wherein the correspondence relation includes physical quantities to be set as values fulfilling functions including a receiving notification of an e-mail and a count-down timer.

7. The electronic timepiece according to claim 1,
wherein the acquisition section acquires information indicating the correspondence relation, and
the controller allows the storage Section to store information indicating the correspondence relation acquired by the acquisition section.

8. An electronic timepiece system comprising:
the electronic timepiece according to claim 1; and
an electronic device including a communication section which can communicate with the acquisition section and can transmit/receive the command, which is stacked over/under the electronic timepiece.

9. The electronic timepiece system according to claim 8,
wherein the electronic timepiece transmits a request signal to the electronic device, which requests transmission of the command to the acquisition section.

10. The electronic timepiece system according to claim 8,
wherein the electronic timepiece transmits a control end signal to the electronic device by the command, which notifies the end of control in a state where the control of the drive section based on the control items and physical quantities corresponding to the command is completed.

11. The electronic timepiece system according to claim 8,
wherein the electronic device includes a power source, and
the electronic timepiece includes a power source different from the above power source.

12. The electronic timepiece system according to claim 8,
wherein the electronic device is mounted on an attaching portion which can be attached to a user's arm in a state where the electronic timepiece is stacked.

13. A method of controlling the electronic timepiece comprising the steps of:
acquiring a command for controlling hands driven to be rotated along a display dial regardless of the time;
storing correspondence relation between the command and physical quantities corresponding to control items of a drive section which drives the hands; and
controlling the drive section based on the obtained physical quantities by referring to the correspondence relation by using the acquired command to drive the hands.
